(19) United States
(12) Patent Application Publication
(10) Pub. No.: US 2026/0322042 A1
(43) Pub. Date: Oct. 15, 2026

(54) FERRITE CORE ASSEMBLY FOR ELECTRICAL CONNECTOR

(71) Applicant: TE Connectivity Solutions GmbH, Schaffhausen (CH)

(72) Inventors: Thomas RAMUNNO, Schaffhausen (CH); Steven LORD, Schaffhausen (CH); Xavier ROUILLARD, Schaffhausen (CH); Cathérine CAMARA, Schaffhausen (CH)

(21) Appl. No.: 19/467,119

(22) Filed: Feb. 2, 2026

(30) Foreign Application Priority Data
Feb. 5, 2025 (EP) 25305167.6

(51) Int. Cl. H01R 13/6588; H01R 13/502; H01R 13/6598

(52) U.S. Cl. CPC H01R 13/6588; H01R 13/502; H01R 13/6598

(57) ABSTRACT

A ferrite core assembly for an electrical connector includes a first ferrite core having a first engagement face and a second ferrite core having a second engagement face. The first ferrite core is configured to be arranged on the second ferrite core according to a mounting direction so that the first engagement face is facing the second engagement face. The engagement faces provides an abutment of the first ferrite core against the second ferrite core along a transversal direction, wherein the transversal direction is perpendicular to the mounting direction.

### CROSS REFERENCE TO RELATED APPLICATIONS

This application claims the benefit of EP Application No. 25305167.6, filed 5 Feb. 2025, the subject matter of which is herein incorporated by reference in its entirety.

### BACKGROUND OF THE INVENTION

The subject matter herein relates to a ferrite core assembly for an electrical connector, in particular for a pyrotechnic connector to be plugged in a mating connector of a safety restraint system.

A ferrite core is a component made of ferrite material, typically used for its magnetic properties and high electrical resistance. It is particularly effective in suppressing high-frequency noise and electromagnetic interference (EMI).

Ferrite cores are commonly used in electrical connectors, such as pyrotechnic connectors (also known as squid connectors), to suppress high-frequency noise and electromagnetic interference (EMI), thereby preserving the integrity of the signal transmission.

It is known from the state of the art, for instance from US2003162444A1 and US2002009924A1 to use split ferrite cores, which are composed of two halves that surrounds the cable. To maintain the effective functioning of a split ferrite core, it is however important to prevent relative movement between its halves. A lateral or misaligned displacement could create gaps in the magnetic path, reducing the ferrite's efficiency in attenuating EMI. In US2003162444A1, the prevention of lateral movement between the halves is achieved through latch arms and holding arms of the insulating housing, that hold the ferrite members in place. In US2002009924A1, the ferrite component is hold within the housing by retention clips on the housing wall that engage locking ledges on the ferrite component. Moreover, a deflectable protrusion applies a retentive force to hold the ferrite component against the retention clips.

These solutions, however, require specific and complex features housing features. It would be desirable to provide a simplified and effective solution to prevent the relative movement of ferrite halves at least along one direction.

### BRIEF DESCRIPTION OF THE INVENTION

In one embodiment, a ferrite core assembly for an electrical connector is provided, in particular for a pyrotechnic connector to be plugged in a mating connector of a safety restraint system. The ferrite core assembly includes a first ferrite core comprising a first engagement face, and a second ferrite core comprising a second engagement face, the first ferrite core is configured to be arranged on the second ferrite core according to a mounting direction so that the first engagement face is facing the second engagement face, at least one channel for receiving a terminal or a wire along an extension direction is defined between the first engagement face and the second engagement face, the extension direction being perpendicular to the mounting direction, and the first engagement face and the second engagement face provides an abutment of the first ferrite core against the second ferrite core along a transversal direction, wherein the transversal direction is respectively perpendicular to the mounting direction and the extension direction.

The abutment of the first ferrite core against the second ferrite core along a transversal direction prevents unwanted relative displacement between the two ferrite cores. This prevents the creation of gaps in the magnetic path that could be caused by movement of the ferrite cores. The movement-blocking function in at least one direction is achieved by the features of the ferrite core assembly itself, particularly by the first and second engagement faces, without requiring additional blocking means provided by the housing of an electrical connector in which the ferrite core assembly may be housed. This provides a simplified and effective solution to prevent relative movement of the two ferrite cores along at least one direction.

As used herein, the terms “first” and “second” in relation to the ferrite core are employed for distinguishing between the two ferrite cores of the ferrite core assembly and may not imply a particular order, sequence, or hierarchy.

According to one embodiment, the first engagement face and the second engagement face may provide mutual abutment between the first ferrite core and the second ferrite core in both opposite directions along the transversal direction.

The mutual abutment between the first engagement face and the second engagement face prevents displacement and misalignment of the first and second ferrite cores in both opposite directions along the transversal direction. It further secures the position of the first ferrite core with respect to the second ferrite core.

According to one embodiment, the ferrite core assembly may be characterized in that the mutual displacement of the first and second ferrite cores in both opposite directions along the transversal direction is locked exclusively by the ferrite core assembly, without the use of additional latching means, locking means, or housing features distinct from the ferrite core assembly.

According to one embodiment, the ferrite core assembly may have a rectangular shape or a cuboidal shape. The ferrite core assembly may have chamfered or rounded edges. In the context of the present description, the first ferrite core defines a half ferrite of the ferrite core assembly. The second ferrite core defines another half ferrite of the ferrite core assembly. Each of the first ferrite core and the second ferrite core may be respectively machined from a ferrite block. According to one embodiment, the first ferrite core and the second ferrite core may have the same shape. This simplifies production, as only one shape is required, and facilitates logistics for assembly. Alternatively, the first ferrite core may have a shape that is complementary to and different from the shape of the second ferrite core. This configuration can facilitate specific mutual abutment, improving the prevention of transversal movement between the two ferrite cores.

According to one embodiment, at least one of the first ferrite core and the second ferrite core may be provided with at least one locking ridge projecting perpendicularly from its engagement face and extending longitudinally along the extension direction. Hence, the ferrite core is provided with a locking ridge that may engage with a corresponding feature to restrict relative movement between the two ferrite cores along the transversal direction, particularly without the need for additional blocking means from the housing of an electrical connector in which the ferrite core assembly may be housed. In one embodiment, the at least one locking ridge may extend longitudinally along the extension direction from a front face of the ferrite core assembly up to a back face of the ferrite core assembly. Alternatively, the at least one locking ridge may extend only partially from the front face, respectively from the back face, of the ferrite core assembly, towards the back face, respectively the front face, of the ferrite core assembly.

According to one embodiment, at least one locking ridge of the first ferrite core may abut against at least one locking ridge of the second ferrite core along the transversal direction. This abutment between two locking ridges may create more surface contact between the first and second ferrite cores. It may enable to further restrict movement along the transversal direction.

The first engagement face and the second engagement face may respectively be provided with guiding features. The guiding features may be configured to facilitate the alignment of the first ferrite core with respect to the second ferrite core during the assembly of the ferrite core assembly. According to one embodiment, the at least one locking ridge may comprise a lateral wall parallel to a lateral face of the first ferrite core or the second ferrite core, the lateral face being defined in a plane formed by the extension direction and the mounting direction. By providing a lateral wall of the locking ridge that is parallel to the lateral face of the ferrite core, a surface normal to the transversal direction is created. This may enhance the ability to restrict movement along the transversal direction. Moreover, this parallel configuration may facilitate positioning of the first ferrite core with respect to the second ferrite by means of the locking ridge.

According to one embodiment, at least one of the first ferrite core and the second ferrite core may be provided with at least one locking recess deepening perpendicularly from the respective engagement face of the ferrite core and extending longitudinally along the extension direction. The locking recess provides a defined cavity or groove for engagement with a corresponding feature, restricting relative movement along the transversal direction, particularly without the need for additional blocking means from the housing of an electrical connector in which the ferrite core assembly may be housed. In one embodiment, the at least one locking recess may extend longitudinally along the extension direction from a front face of the ferrite core assembly up to a back face of the ferrite core assembly. Alternatively, the at least one locking recess may extend only partially from the front face, respectively from the back face, of the ferrite core assembly, towards the back face, respectively the front face, of the ferrite core assembly.

According to one embodiment, the at least one locking ridge of the first ferrite core, respectively of the second ferrite core, may be at least partially received and interlocked in the at least one locking recess of the second ferrite core, respectively of the first ferrite core. The interlocking engagement of the locking ridge within the locking recess forms a form-fit connection, preventing relative movement between the first and second ferrite cores in both opposite directions along the transversal direction. This form-fit connection enhances the stability and alignment of the ferrite core assembly. In particular, it achieves these effects without relying on additional blocking features distinct from the ferrite core assembly.

According to one embodiment, the at least one channel may have an oblong or circular cross-section in a plane formed by the mounting direction and the transversal direction. The at least one channel is thus adapted for receiving a cable or a wire. Alternatively, the at least one channel may have a rectangular cross-section in a plane formed by the mounting direction and the transversal direction. In particular, the at least one channel may be dimensioned to receive an electrical terminal rather than a cable. Because a cross-section of an electrical terminal is smaller than the one of a cable, a ferrite core assembly with a rectangular channel for an electrical terminal is more compact than a ferrite core assembly designed to accommodate cables.

The longest dimension of the rectangular channel, measured in the plane defined by the mounting and transverse directions, may be parallel to the projection direction of a locking ridge. This configuration may provide a more compact ferrite core assembly than in a configuration wherein the longest dimension of the rectangular channel, measured in the plane defined by the mounting and transverse directions, is perpendicular to the projection direction of a locking ridge.

According to one embodiment, the ferrite core assembly may comprise two distinct channels. Hence, each channel is configured to receive an individual electrical terminal or cable. This arrangement allows for separation and alignment of the electrical terminal or cable within the ferrite core assembly. The respective opening of the channels at a front face and/or at a back face of the ferrite core assembly may be chamfered inward toward the interior of the respective channel. This may reduce the risk of damaging the electrical terminals or wires during assembly.

According to one embodiment, at least one of the first ferrite core and the second ferrite core may comprise a recess extending along the extension direction, and the at least one channel may be partially formed by the recess. The recess may be dimensioned to accommodate an electrical terminal or a cable. According to one embodiment, the recess configured to accommodate the electrical terminal or cable may correspond to a locking recess of one of the ferrite cores. According to another embodiment, the first ferrite core may comprise a recess or a groove extending along the extension direction. The second ferrite core may comprise a corresponding recess or groove extending along the extension direction. The channel may be formed by the recess or groove of the first ferrite core facing the corresponding recess or groove of the second ferrite core.

According to one embodiment, the at least one channel may be formed between the at least one locking ridge of the first ferrite core, respectively of the second ferrite core, and the second engagement face of the second ferrite, respectively of the first engagement face of the first ferrite core. In particular, the at least one channel may be formed between a locking ridge of the first ferrite core, respectively of the second ferrite core, and a recess of the second ferrite core, respectively of the first ferrite core. This configuration provides a more compact solution, as the locking ridge simultaneously serves as a form-fit connection to prevent mutual displacement of the ferrite cores and as a channel for receiving the electrical terminal or cables. The at least one channel may be at least partially defined by a lateral wall of a locking ridge of one of the ferrite cores. The at least one channel may be at least partially defined between a lateral wall of a locking ridge of the first ferrite core and a lateral wall of a locking ridge of the second ferrite core. The at least one channel may be at least partially defined between two lateral walls of a locking recess of one of the ferrite cores.

According to one embodiment, the first engagement face and the second engagement face may be further configured to provide an abutment of the first ferrite core against the second ferrite core along the extension direction. The abutment along the extension direction provides additional stability to the ferrite core assembly by restricting relative movement of the first and second ferrite cores in two directions, namely the transversal direction and the extension direction. The abutment of the first ferrite core against the second ferrite core along the extension direction may be achieved by the abutment of a locking ridge of the first ferrite core against a corresponding locking ridge, or a corresponding locking recess, of the second ferrite core along the extension direction.

The number of locking ridges and/or locking recesses in the ferrite core assembly is not limitative.

In a further embodiment, an electrical connector is provided, in particular for a pyrotechnic connector, to be plugged in a mating connector, in particular a mating connector of a safety restraint system, along a mounting direction. The electrical connector includes a connector housing for housing an electrical terminal or a wire, and a ferrite core assembly, the ferrite core assembly being accommodated in the connector housing, and the ferrite core assembly comprises at least one channel for receiving the electrical terminal or wire along an extension direction, the extension direction being perpendicular to the mounting direction, and the ferrite core assembly comprises a first ferrite core comprising a first engagement face and a second ferrite core comprising a second engagement face, the first ferrite core is configured to be arranged on the second ferrite core according to the mounting direction so that the first engagement face is facing the second engagement face, and the first engagement face and the second engagement face are configured to provide an abutment of the first ferrite core against the second ferrite core along a transversal direction, wherein the transversal direction is respectively perpendicular to the mounting direction and the extension direction.

The electrical connector may be characterized by the absence of latching means in the connector housing for holding the first ferrite core with respect to second ferrite core. This allows simplifying the design of the connector housing. The electrical connector may comprise a receptacle for housing a wire fixture.

In a further embodiment, an assembly method is provided for assembling a ferrite core assembly to an electrical connector. The assembly method may comprise a step for inserting the first ferrite core in the connector housing along the mounting direction, a step of introducing at least one electrical terminal or wire in the corresponding channel of the first ferrite core along the mounting direction and a step of inserting the second ferrite core along the mounting direction to arrange the second ferrite core on the first ferrite core. This assembly method allows assembling the different components along a single direction, namely the mounting direction, enabling a vertical assembly process. This vertical sequence eases the assembly process.

### BRIEF DESCRIPTION OF THE DRAWINGS

The accompanying drawings are incorporated into the specification and form a part of the specification to illustrate several embodiments of the present invention. These drawings, together with the description serve to explain the principles of the invention. The drawings are merely for the purpose of illustrating the preferred and alternative examples of how the invention can be made and used, and are not to be construed as limiting the invention to only the illustrated and described embodiments. Furthermore, several aspects of the embodiments may form-individually or in different combinations-solutions according to the present invention. The following described embodiments thus can be considered either alone or in an arbitrary combination thereof. Further features and advantages will become apparent from the following more particular description of the various embodiments of the invention, as illustrated in the accompanying drawings, in which like references refer to like elements, and wherein:

FIG. 1 represents a ferrite core assembly 10 according to a first embodiment.

FIG. 2 represents one ferrite core of the ferrite core assembly 10.

FIG. 3 represents a ferrite core assembly 20 according to a second embodiment.

FIG. 4 represents one ferrite core of the ferrite core assembly 20.

FIG. 5 represents a ferrite core assembly 30 according to a third embodiment.

FIG. 6 represents one ferrite core of the ferrite core assembly 30.

FIG. 7 represents a ferrite core assembly 40 according to a fourth embodiment.

FIG. 8 represents one ferrite core of the ferrite core assembly 40.

FIG. 9 represents a ferrite core assembly 50 according to a fifth embodiment.

FIG. 10 represents an exploded view of the ferrite core assembly 50.

FIG. 11 represents a ferrite core assembly 60 according to a sixth embodiment.

FIG. 12 represents an exploded view of the ferrite core assembly 60.

FIGS. 13A, 13B, 13C and 13D respectively represent step of an assembly method of a ferrite core assembly.

As used thereafter, reference signs ending with the Latin letter “A” (such as 100A or 102A) refers to the first ferrite core, whereas the reference sign ending with the Latin letter “B” (such as 100B, 102B) refers the second ferrite core of the ferrite core assembly.

### DETAILED DESCRIPTION OF THE INVENTION

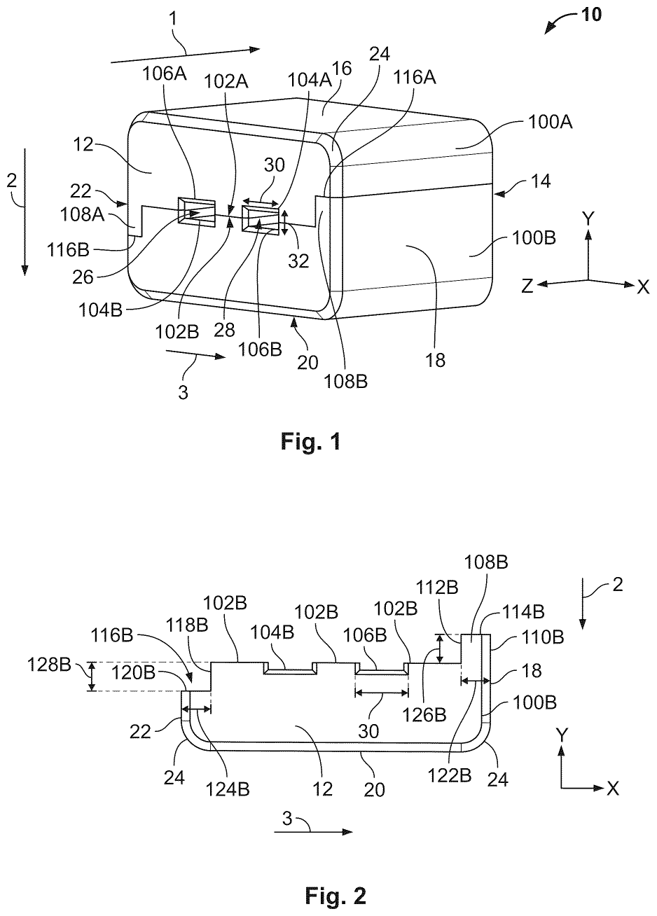

FIG. 1 shows a ferrite core assembly 10 according to a first embodiment. The ferrite core assembly 10 has the shape of a rectangular prism. The ferrite core assembly 10 comprises a front face 12 opposite a back face 14 along an extension direction 1. The extension direction 1 is shown by the arrow 1 and is parallel to the Z-axis of the Cartesian coordinate system shown in FIG. 1. The front face 12, respectively the back face 14, has a rectangular shape. The front face 12 and the back face 14 are connected by four lateral walls 16, 18, 20, 22. The two lateral face 16 and 20 are opposite each other along the Y-axis of the Cartesian coordinate system shown in FIG. 1. The two lateral face 18 and 22 are opposite each other along the X-axis of the Cartesian coordinate system shown in FIG. 1. The lateral faces 16, 18, 20, 22 are respectively joined at their intersections by chamfered edges 24.

The ferrite core assembly 10 comprises two distinct channels 26, 28. Each channel 26, 28 is configured to receive one electrical terminal (not represented) along the extension direction 1. The two channels 26, 28 have identical dimensions and shapes. Each channel 26, 28 extends from the front face 12 to the back face 14 of the ferrite core assembly 10.

In the first embodiment, each channel 26, 28 has a hollow rectangular cross-section in a plane parallel to the front face 12, with two parallel lengths 30 and two parallel widths 32. The parallel lengths 30 are respectively greater than the parallel widths 32. The lengths 30 are parallel to the X-axis of the Cartesian coordinate system shown in FIG. 1, while the widths 32 are parallel to the Y-axis of said system.

In the first embodiment, the channels 26, 28 are positioned such that the parallel lengths 30 of the rectangular cross-section of channel 26 are aligned with the corresponding parallel lengths 30 of the rectangular cross-section of channel 28. Each channels 26, 28 are respectively dimensioned for receiving an electrical terminal. In particular, the channels 26, 28 are configured to receive an electrical terminal of rectangular cross-section.

On the front face 12, respectively on the back face 14, each channel 26, 28 is chamfered inwardly towards the back face 14, respectively towards the front face 12. It allows preventing sharp edges that could scrape or damage the electrical terminal during their insertion in the ferrite core assembly.

According to the invention, the ferrite core assembly 10 comprises a first ferrite core 100A and a second ferrite core 100B.

In the first embodiment, the first ferrite core 100A and the second ferrite core 100B have the same shape. As the two ferrite cores 100A, 100B are identical, only one ferrite core 100B is depicted in FIG. 2. The description of the second ferrite core 100B shown in FIG. 2 equally applies to the first ferrite core 100A.

The first ferrite core 100A comprises a first engagement face 102A. The second ferrite core 100B comprises a second engagement face 102B. In the ferrite core assembly 10, as depicted by FIG. 1, the first ferrite core 100A is arranged on the second ferrite core 100B according to a mounting direction 2 so that the first engagement face 102A faces the second engagement face 102B. The first engagement face 102A is partially in surface contact with the second engagement face 102B. More precisely, the first engagement face 102A is in surface contact with the second engagement face 102B except where channels 26, 28 are present. Each channel 26, 28 is defined between the first engagement face 102A and the second engagement face 102B. In particular, each ferrite core 100A, 100B comprises two conductor grooves 104, 106 respectively extending along the extension direction 1 from the front face 12 to the back face 14. In the first embodiment, the conductor grooves 104, 106 are formed by rectangular grooves. Each channel 26, 28 is formed by the conductor groove 104A, 106A of the first ferrite core 100A facing the corresponding conductor groves 104B, 106B of the second ferrite core 100B. As shown in FIG. 2, each conductor groove 104B, 106B is recessed into the second ferrite core 100B from the engagement face 102B to a depth equal to half of the width 32 of the rectangular cross-section of the channels 26, 28. The groove width (30) of each conductor groove 104B, 106B corresponds to the length 30 of the rectangular cross-section of the channels 26, 28. The same applies for the conductor grooves 104A, 106A of the first ferrite core 100A.

The first engagement face 102A and the second engagement face 102B are configured to provide an abutment of the first ferrite core 100A against the second ferrite core 100B along a transversal direction 3. The transversal direction 3 is respectively perpendicular to the extension direction 1 and the mounting direction 2. The transversal direction 3 is parallel to the X-axis of the Cartesian coordinate system shown in FIG. 1.

Each of the first ferrite core 100A and the second ferrite core 100B is provided with a respective locking ridge 108A, 108B. Each locking ridge 108A, 108B projects perpendicularly from the respective engagement face 102A, 102B and extends longitudinally along the extension direction 1, in particular from the front face 12 until the back face 14. Each locking ridge 108A, 108B has a solid rectangular cross-section in a plane parallel to the front face 12.

As shown in FIG. 2, the locking ridge 108B of the second ferrite core 100B has one external lateral wall 110B that is flush with the lateral face 18. In other words, the external lateral wall 110B is formed as an extension of the lateral face 18. The locking ridge 108B comprises one internal lateral wall 112B, opposite the external lateral wall 110B. Both lateral walls 110B, 112B extend in a (YZ) plane. The locking ridge 108B comprises a top surface 114B. The top surface 114B connects the external lateral wall 110B to the internal lateral wall 112B. The top surface 114B extends in a (XZ) plane. The same description applies to the locking ridge 108A of the first ferrite core 100A.

Moreover, each of the first ferrite core 100A and the second ferrite core 100B is provided with a respective locking recess 116A, 116B. Each locking recess 116A, 116B is deepened perpendicularly from the respective engagement face 102A, 102B and extends longitudinally along the extension direction 1, in particular from the front face 12 until the back face 14.

As shown in FIG. 2, the locking recess 116B of the second ferrite core 100B is opened to the lateral face 22, which is opposite to the lateral face 18. Hence, the locking recess 116B comprises only one lateral wall 118B. The lateral wall 118B extends in a (YZ) plane. The lateral wall 118B of the locking recess 116B is parallel to the lateral face 22. The lateral wall 118B of the locking recess 116B is parallel to the internal lateral wall 112B of the locking ridge 108B. The locking recess 116B is provided with a bottom surface 120B. The bottom surface 120B extends in a (XZ) plane. The bottom surface 120B of the locking recess 116B is parallel to the top surface 114B of the locking ridge 108B. The same description applies to the locking recess 116A of the first ferrite core 100A.

The width 122B of the locking ridge 108B corresponds to the width 124B of the locking recess 116B. The width 122B of the locking ridge 108B is defined between the external lateral wall 110B and the internal lateral wall 112B of the locking ridge 108B along the X-axis. The width 124B of the locking recess 116B is defined along the X-axis at the bottom surface 120B between the lateral face 22 and the lateral wall 118B. The same description applies to the first ferrite core 100A.

The height 126B of the locking ridge 108B corresponds to the depth 128B of the locking recess 116B. The height 126B of the locking ridge 108B is defined between the second engagement face 102B and the top surface 114B of the locking ridge 108B along the Y-axis. The depth 128B of the locking recess 116B is defined between the second engagement face 102B and the bottom surface 124B of the locking recess 116B along the Y-axis. The same description applies to the first ferrite core 100A.

In the ferrite core assembly 10, the top surface 108A of the first ferrite core 100A is in surface contact with the bottom surface 120B of the second ferrite core 100B. The bottom surface 120A of the first ferrite core 100A is in surface contact with the top surface 108B of the second ferrite core 100B.

The locking ridge 108A of the first ferrite core 100A and the locking recess 116B of the second ferrite core 100B, respectively the locking ridge 108B of the second ferrite core 100B and the locking recess 116A of the first ferrite core 100A, have complementary shapes. As shown in FIG. 1, the locking ridge 108A of the first ferrite core 100A interlocks with the locking recess 116B of the second ferrite core 100B. The locking recess 116A of the first ferrite core 100A interlocks with the locking ridge 108B of the second ferrite core 100B. This interlocked arrangement prevent a displacement of the first ferrite core 100A relative to the second ferrite core 100B in the sense indicated by the arrow showing the transversal direction 3. In particular, an abutment of the internal lateral wall 112A of the locking ridge 108A of the first ferrite core 100A against the lateral wall 118B of the locking recess 116B of the second ferrite core 100B blocks a movement of the first ferrite core 100A relative to the second ferrite core 100B in the sense indicated by the arrow showing the transversal direction 3. Similarly, an abutment of the lateral wall 118A of the locking recess 116A of the first ferrite core 100A against the internal lateral wall 112B of the locking ridge 108B of the second ferrite core 100B blocks a movement of the first ferrite core 100A relative to the second ferrite core 100B in the sense indicated by the arrow showing the transversal direction 3.

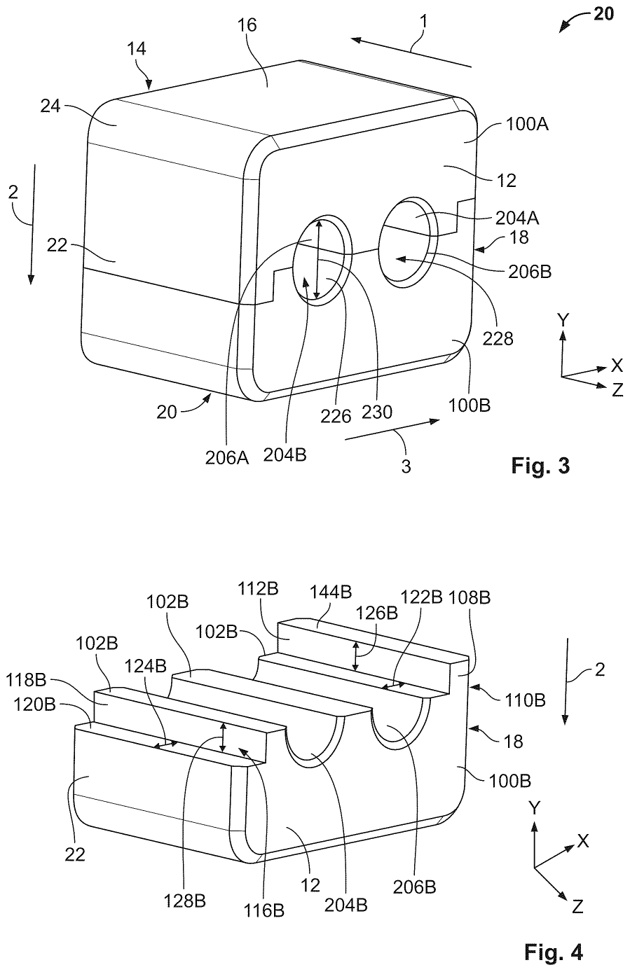

FIG. 3 shows a ferrite core assembly 20 according to a second embodiment.

Elements with the same reference numeral already described and illustrated in FIGS. 1 and 2 will not be described in detail again but reference is made to their description above.

The ferrite core assembly 20 differs from the ferrite core assembly 10 in that the channels 226, 228 of the ferrite core assembly 20 respectively have a hollow circular cross-section in a plane parallel to the front face 12, rather than a hollow rectangular cross-section. Each channel 226, 228 is defined between the first engagement face 102A and the second engagement face 102B. In particular, each ferrite core 100A, 100B comprises two conductor grooves 204, 206 respectively extending along the extension direction 1 from the front face 12 to the back face 14. In the second embodiment, the conductor grooves 204, 206 are respectively formed as semi-circular grooves. Each channel 226, 228 has a diameter 230. Each channel 226, 228 is formed by the conductor groove 204A, 206A of the first ferrite core 100A facing the corresponding conductor groves 204B, 206B of the second ferrite core 100B. As shown in FIG. 4, each conductor groove 204B, 206B is recessed into the second ferrite core 100B from the engagement face 102B.

The channels 226, 228 are configured to receive a wire or a cable of circular cross-section. The volume of the hollow channels 26, 28 according to the first embodiment may be smaller than the volume of the hollow channels 226, 228 according to the second embodiment. The overall size of the ferrite core assembly 10 may thus be advantageously reduced with respect to the overall size of the ferrite core assembly 20.

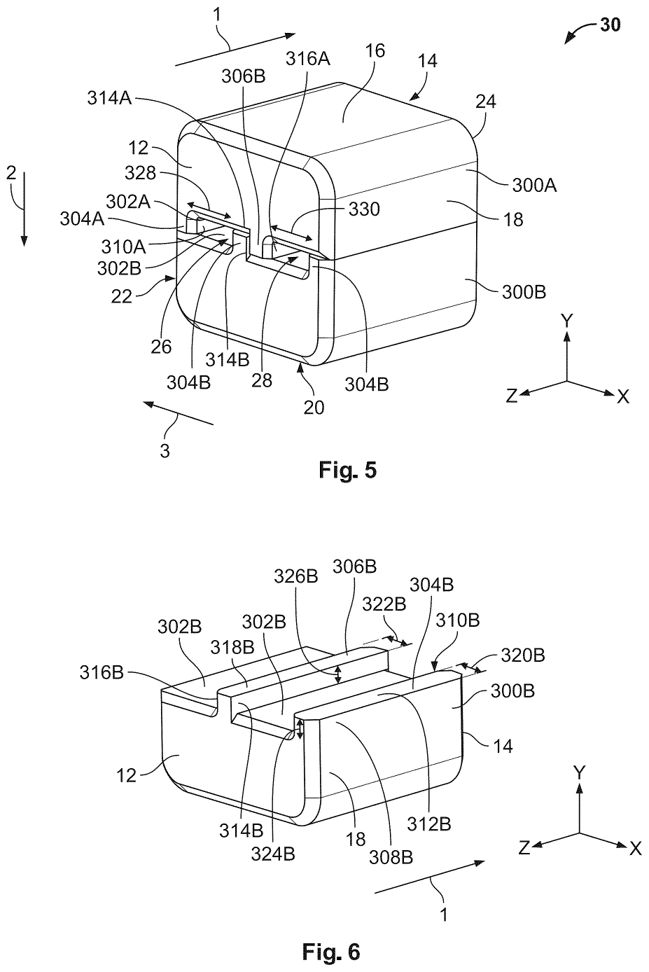

FIG. 5 shows a ferrite core assembly 30 according to a third embodiment.

Elements with the same reference numeral already described and illustrated in FIGS. 1 and 2 will not be described in detail again but reference is made to their description above.

According to the invention, the ferrite core assembly 30 comprises a first ferrite core 300A and a second ferrite core 300B. The first ferrite core 300A comprises a first engagement face 302A. The second ferrite core 300B comprises a second engagement face 302B. In the ferrite core assembly 30, as depicted by FIG. 5, the first ferrite core 300A is arranged on the second ferrite core 300B according to the mounting direction 2 so that the first engagement face 302A faces the second engagement face 302B.

In the third embodiment, like in the first embodiment and the second embodiment, the first ferrite core 300A and the second ferrite core 300B have the same shape. As the two ferrite cores 300A, 300B are identical, only one ferrite core 300B is depicted in FIG. 6. The description of the second ferrite core 300B shown in FIG. 6 equally applies to the first ferrite core 300A.

The ferrite core assembly 30 comprises two distinct channels 26, 28. The channels 26, 28 are defined between the first engagement face 302A and the second engagement face 302B. Each channel 26, 28 has a rectangular cross-section in a plane parallel to the front face 12, i.e. in an (XY) plane. On the front face 12, respectively on the back face 14, each channel 26, 28 is chamfered inwardly towards the back face 14, respectively towards the front face 12. It allows preventing sharp edges that could scrape or damage the electrical terminal during their insertion in the ferrite core assembly. Each channels 26, 28 are respectively dimensioned for receiving an electrical terminal. In particular, the channels 26, 28 are configured to receive an electrical terminal of rectangular cross-section.

The first engagement face 302A and the second engagement face 302B are configured to provide an abutment of the first ferrite core 300A against the second ferrite core 300B along the transversal direction 3. As mentioned with respect to the first embodiment, the transversal direction 3 is respectively perpendicular to the extension direction 1 and the mounting direction 2. The transversal direction 3 is parallel to the X-axis of the Cartesian coordinate system shown in FIG. 5.

In the third embodiment, the first ferrite core 300A and the second ferrite core 300B are respectively provided with two locking ridges 304, 306. Accordingly, the first ferrite core 300A is provided with a first locking ridge 304A and a second locking ridge 306A. Similarly, the second ferrite core 300B is provided with a first locking ridge 304B and a second locking ridge 306B. Each locking ridge 304A, 306A, 304B, 304B has a solid rectangular cross-section in a plane parallel to the front face 12

Each first locking ridge 304A, 304B projects perpendicularly from the respective engagement face 302A, 302B and extends longitudinally along the extension direction 1, in particular from the front face 12 until the back face 14. As better shown in FIG. 6, the first locking ridge 304B of the second ferrite core 300B has one external lateral wall 308B that is flush with the lateral face 18. In other words, the external lateral wall 308B is formed as an extension of the lateral face 18. The first locking ridge 304B comprises one internal lateral wall 310B, opposite the external lateral wall 308B. Both lateral walls 308B, 310B extend in a (YZ) plane. The first locking ridge 304B comprises a top surface 312B. The top surface 312B connects the external lateral wall 308B to the internal lateral wall 310B. The top surface 312B extends in a (XZ) plane. The same description applies to the first locking ridge 304A of the first ferrite core 300A.

Each second locking ridge 306A, 306B projects perpendicularly from the respective engagement face 302A, 302B and extends longitudinally along the extension direction 1, in particular from the front face 12 until the back face 14. As better shown in FIG. 6 with respect to the second ferrite core 300B, the second locking ridge 306B of the second ferrite core 300B is positioned equidistant from the lateral face 22 and the internal lateral wall 310B of the first locking ridge 304B. The second locking ridge 306B extends parallel from the first ridge 304B along the extension direction 1.The second locking ridge 306B comprises two opposite lateral walls 314B, 316B. Both lateral walls 314B, 316B extend in a (YZ) plane. The second locking ridge 306B comprises a top surface 318B. The top surface 318B connects the two lateral walls 314B, 316B. The top surface 318B extends in a (XZ) plane. The same description applies to the second locking ridge 306A of the first ferrite core 300A.

In the example shown by FIGS. 5 and 6, the width 320B of the first locking ridge 304B corresponds to the width 322B of the second locking ridge 306B. The width 320B of the first locking ridge 304B is defined between the external lateral wall 308B and the internal lateral wall 310B of the first locking ridge 304B along the X-axis. The width 322B of the second locking ridge 306B is defined between the two walls 314B, 316B along the X-axis. The same description applies to the first ferrite core 100A.

In a variant of the third embodiment not represented, the width 320A, 320B of the first locking ridge 304A, 304B is different from the width 322A, 322B of the second locking ridge 306A, 306B.

The height 324B of the first locking ridge 304B corresponds to the height 326B of the second locking ridge 306B. The same description applies to the first ferrite core 300A. These dimensions allows that the top surface 312B of the first locking ridge 304B and the top surface 318B of the second locking ridge 306B are respectively in surface contact with the first engagement face 302A. Similarly, the top surface 312A of the first locking ridge 304A and the top surface 318A of the second locking ridge 306A are respectively in surface contact with the second engagement face 302B.

The heights 324B, 326B define the respective heights of the rectangular channel 26, 328. The length 328 of the rectangular channel 26 is defined along the X-axis between the internal lateral wall 310A of the first locking ridge 304A and the lateral wall 316B of the second locking ridge 306B. The length 330 of the rectangular channel 28 is defined along the X-axis between the lateral wall 316A of the second locking ridge 306A and the internal lateral wall 310B of the first locking ridge 304B. The length 328 is equal to the length 330. The lengths 328, 330 are respectively greater than the widths 324A, 324B, 326A, 326B. The lengths 328, 330 are parallel to the X-axis of the Cartesian coordinate system shown in FIG. 5, while the widths 324A, 324B, 326A, 326B are parallel to the Y-axis of said system.

In the ferrite core assembly 30 according to the third embodiment, the lateral wall 314A of the second locking ridge 306A of the first ferrite core 300A abuts against the lateral 314B of the second locking ridge 306B of the second ferrite core 300B along the transversal direction 3. The lateral wall 314A and the lateral wall 314B are in surface contact from the front face 12 to the back face 14.

In the third embodiment, a displacement of the first ferrite core 300A relative to the second ferrite core 300B in the sense indicated by the arrow showing the transversal direction 3 is prevented. In particular, the abutment of the lateral wall 314A of the second locking ridge 306A of the first ferrite core 300A against the lateral 314B of the second locking ridge 306B of the second ferrite core 300B blocks a movement of the first ferrite core 100A relative to the second ferrite core 100B in the sense indicated by the arrow showing the transversal direction 3.

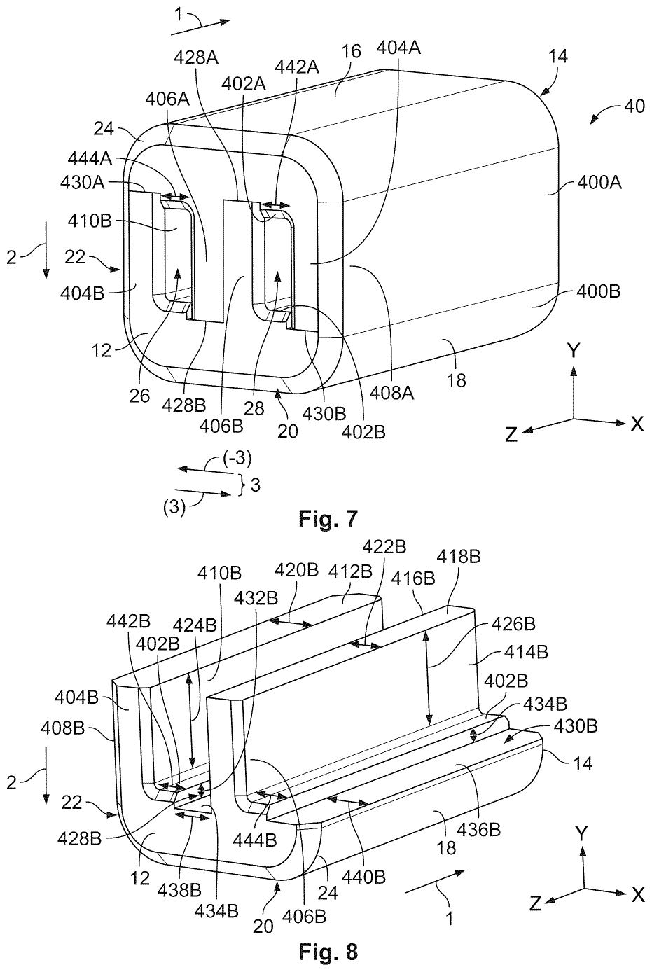

FIG. 7 shows a ferrite core assembly 40 according to a fourth embodiment.

Elements with the same reference numeral already described and illustrated in FIGS. 1 and 2 will not be described in detail again but reference is made to their description above.

According to the invention, the ferrite core assembly 40 comprises a first ferrite core 400A and a second ferrite core 400B. The first ferrite core 400A comprises a first engagement face 402A. The second ferrite core 400B comprises a second engagement face 402B. In the ferrite core assembly 40, as depicted by FIG. 7, the first ferrite core 400A is arranged on the second ferrite core 400B according to the mounting direction 2 so that the first engagement face 402A faces the second engagement face 402B.

In the fourth embodiment, like in the first, second and third embodiments, the first ferrite core 400A and the second ferrite core 400B have the same shape. As the two ferrite cores 400A, 400B are identical, only one ferrite core 400B is depicted in FIG. 8. The description of the second ferrite core 400B shown in FIG. 8 equally applies to the first ferrite core 400A.

The ferrite core assembly 40 comprises two distinct channels 26, 28. The channels 26, 28 are defined between the first engagement face 402A and the second engagement face 402B. Each channels 26, 28 has a rectangular cross-section in a plane parallel to the front face 12, i.e. in an (XY) plane. On the front face 12, respectively on the back face 14, each channel 26, 28 is chamfered inwardly towards the back face 14, respectively towards the front face 12. It allows preventing sharp edges that could scrape or damage the electrical terminal during their insertion in the ferrite core assembly. Each channels 26, 28 are respectively dimensioned for receiving an electrical terminal. In particular, the channels 26, 28 are configured to receive an electrical terminal of rectangular cross-section.

In the fourth embodiment, the first engagement face 402A and the second engagement 402B face provide mutual abutment between the first ferrite core 400A and the second ferrite core 400B in both opposite directions along the transversal direction 3. One direction along the transversal direction 3 is indicated by the arrow labelled with the reference sign (3). The opposite direction along the transversal direction 3 is shown by the arrow labelled with the reference sign (−3). The directions (3) and (−3) along the transversal direction 3 are parallel but opposite to each other. The transversal direction 3 is respectively perpendicular to the extension direction 1 and the mounting direction 2. The transversal direction 3 is parallel to the X-axis of the Cartesian coordinate system shown in FIGS. 7 and 8.

In the fourth embodiment, and like in the third embodiment, the first ferrite core 400A and the second ferrite core 400B are respectively provided with two locking ridges 404, 406.

Accordingly, the first ferrite core 400A is provided with a first locking ridge 404A and a second locking ridge 406A. Similarly, the second ferrite core 400B is provided with a first locking ridge 404B and a second locking ridge 406B. Each locking ridge 404A, 406A, 404B, 406B has a solid rectangular cross-section in a plane parallel to the front face 12.

Each first locking ridge 404A, 404B projects perpendicularly from the respective engagement face 402A, 402B (i.e. along the Y-axis) and extends longitudinally along the extension direction 1 (i.e. along the X-axis), in particular from the front face 12 until the back face 14.

As better shown in FIG. 8 with respect to the second ferrite core 400B, the first locking ridge 404B of the second ferrite core 400B has one external lateral wall 408B that is flush with the lateral face 22. In other words, the external lateral wall 408B is formed as an extension of the lateral face 22. The first locking ridge 404B comprises one internal lateral wall 410B, opposite the external lateral wall 408B. Both lateral walls 408B, 410B extend in a (YZ) plane. The first locking ridge 404B comprises a top surface 412B. The top surface 412B connects the external lateral wall 408B to the internal lateral wall 410B. The top surface 412B extends in a (XZ) plane. The same description applies to the first locking ridge 404A of the first ferrite core 400A.

Each second locking ridge 406A, 406B projects perpendicularly from the respective engagement face 402A, 402B and extends longitudinally along the extension direction 1, in particular from the front face 12 until the back face 14.

As better shown in FIG. 8 with respect to the second ferrite core 400B, the second locking ridge 406B of the second ferrite core 400B is positioned equidistant from the lateral face 18 and the internal lateral wall 410B of the first locking ridge 404B. The second locking ridge 406B extends parallel from the first ridge 404B along the extension direction 1 (i.e. along the Z-axis). The second locking ridge 406B comprises two opposite lateral walls 414B, 416B. Both lateral walls 414B, 416B extend in a (YZ) plane. The second locking ridge 406B comprises a top surface 418B. The top surface 418B connects the two lateral wall 414B, 416B. The top surface 418B extends in a (XZ) plane. The same description applies to the second locking ridge 406A of the first ferrite core 400A.

The width 420B of the first locking ridge 404B is defined between the external lateral wall 408B and the internal lateral wall 410B of the first locking ridge 404B along the X-axis. The width 422B of the second locking ridge 406B is defined between the two walls 414B, 416B along the X-axis. In the example shown by FIG. 8, the width 420B of the first locking ridge 404B corresponds to the width 422B of the second locking ridge 406B. The same description applies to the first ferrite core 400A.

In a variant of the third embodiment not represented, the width 420A, 420B of the first locking ridge 404A, 404B may be different from the width 422A, 422B of the second locking ridge 406A, 406B.

The height 424B of the first locking ridge 404B corresponds to the height 426B of the second locking ridge 406B. The same description applies to the first ferrite core 400A.

In the fourth embodiment, and unlike in the preceding embodiments, the first ferrite core 400A and the second ferrite core 400B are respectively further provided with two locking recesses 428, 430.

As visible in FIG. 8 with respect to the second ferrite core 400B, the first locking recess 428B is deepened perpendicularly from the engagement face 402A (i.e. along the Y-axis) and extends longitudinally along the extension direction 1 (i.e. along the Z-axis). The first locking recess 428B has a depth, indicated by the reference sign 432B in FIG. 8, which corresponds to the distance between the engagement face 402B and the bottom surface 434B of the first locking recess 428B along the Y-axis. Similarly, the second locking recess 430B is deepened perpendicularly from the second engagement face 402A (i.e. along the Y-axis) and extends longitudinally along the extension direction 1 (i.e. along the Z-axis). The second locking recess 430B has a depth, indicated by the reference sign 434B in FIG. 8, which corresponds to the distance between the second engagement face 402B and the bottom surface 436B of the second locking recess 430B along the Y-axis. The depth 432B of the first locking recess 428B corresponds to the depth 434B of the second locking recess 430B. The same description applies to the first ferrite core 400A.

The first locking recess 428B has a width 438B. The width 438B is defined along the X-axis between the second engagement face 402B and the lateral wall 416B of the second locking ridge 406B. The second locking recess 430B has a width 440B. The width 440B is defined along the X-axis between the second engagement face 402B and the lateral face 18.

The portion of the second engagement face 402 located between the first locking ridge 404B and the first locking recess 428B has a width indicated by the reference sign 442B in FIG. 8. The width 442B is defined along the X-axis between the internal lateral wall 410B and the first locking recess 428B. The portion of the second engagement face 402 located between the second locking ridge 406B and the lateral face 18 has a width indicated by the reference sign 444B in FIG. 8. The width 444B is defined along the X-axis between the lateral wall 414B and the second locking recess 430B. The widths 442A, 422B, 444A, 444B (collectively referred to as 442, 444) have the same value.

The widths 442,444 correspond to the widths of the rectangular channels 26, 28. The heights 424, 426 of the locking ridges 404, 406 correspond to the lengths of the rectangular channels 26, 28. The heights 424, 426 are greater than the widths 442,444.

In the fourth embodiment, all lengths of the two rectangular channels 428, 430 are arranged parallel to each other and parallel to the mounting direction 2 (i.e. Y-axis). Consequently the orientation of the rectangular channels 26, 28 in the fourth embodiment is different from that of the first embodiment and the third embodiment, where the widths, rather than the length, of the two rectangular channels are arranged parallel to each other and parallel to the mounting direction 2 (i.e. Y-axis). The orientation in the fourth embodiment enables a more compact ferrite core assembly 40.

In the fourth embodiment, the first locking ridge 404A of the first ferrite core 400A is partially received in the second locking recess 430B of the second ferrite core 400B. The first locking ridge 404A of the first ferrite core 400A abuts against the second engagement face 402B along the opposite direction (−3) of the transversal direction 3. In particular, the internal lateral wall 410A of the first locking ridge 404A of the first ferrite core 400A abuts against the surface of height 434B of the second engagement face 402B along the opposite direction (−3) of the transversal direction 3. The first locking ridge 404B of the second ferrite core 400B is partially received in the second locking recess 430A of the first ferrite core 400A. The first locking ridge 404B of the second ferrite core 400B abuts against the first engagement face 402A along the direction (3) of the transversal direction 3. In particular, the internal lateral wall 410B of the first locking ridge 404B of the second ferrite core 400B abuts against a surface of height 434A of the first engagement face 402A along the direction (3) of the transversal direction 3.

The width 422A of the second locking ridge 406A of the first ferrite core 400A is similar to the width 438B of the first locking recess 428B of the second ferrite core 400B. In particular, these widths 422A, 438B are adapted such that the second locking ridge 406A of the first ferrite core 400A can be received in the first locking recess 428B of the second ferrite core 400B to provide a form-fit connection. In the fourth embodiment, the second locking ridge 406A of the first ferrite core 400A is partially received in the first locking recess 428B of the second ferrite core 400B. The second locking ridge 406A of the first ferrite core 400A is interlocked with the first locking recess 428B of the second ferrite core 400B. A form-fit connection is formed in both opposite directions (3) and (−3) along the transversal direction 3 between the second locking ridge 406A of the first ferrite core 400A and the first locking recess 428B of the second ferrite core 400B. The lateral wall 416A of the second locking ridge 406A of the first ferrite core 400A abuts against the lateral wall 416B of the second locking ridge 406B of the second ferrite core 400B along the direction (3) of the transversal direction 3. The lateral wall 414A of the second locking ridge 406A of the first ferrite core 400A abuts against the surface of height 428A of the second engagement face 402B along the opposite direction (−3) of the transversal direction 3.

Similarly, the second locking ridge 406B of the second ferrite core 400B is partially received in the first locking recess 428A of the first ferrite core 400A. The second locking ridge 406B of the second ferrite core 400B is interlocked with the first locking recess 428A of the first ferrite core 400A. A form-fit connection is formed in both opposite directions (3) and (−3) along the transversal direction 3 between the second locking ridge 406B of the second ferrite core 400B and the first locking recess 428A of the first ferrite core 400A. The lateral wall 416B of the second locking ridge 406B of the second ferrite core 400B abuts against the lateral wall 416A of the second locking ridge 406A of the first ferrite core 400A along the opposite direction (−3) of the transversal direction 3. The lateral wall 414B of the second locking ridge 406B of the second ferrite core 400B abuts against a surface of height 428B of the first engagement face 402A along the direction (3) of the transversal direction 3.

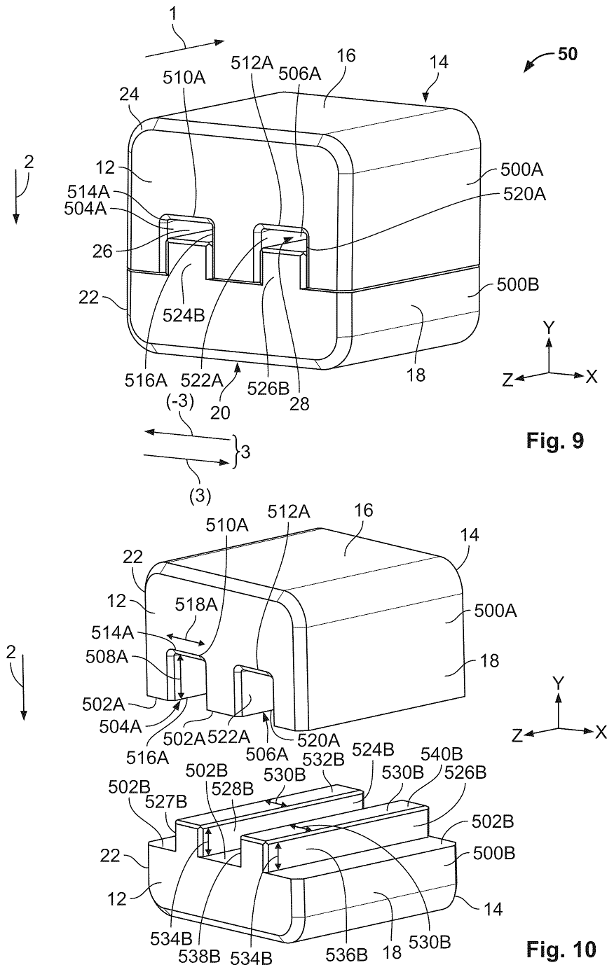

FIG. 9 shows a ferrite core assembly 50 according to a fifth embodiment.

Elements with the same reference numeral already described and illustrated in FIGS. 1 and 2 will not be described in detail again but reference is made to their description above.

According to the invention, the ferrite core assembly 50 comprises a first ferrite core 500A and a second ferrite core 500B. The first ferrite core 500A comprises a first engagement face 502A. The second ferrite core 500B comprises a second engagement face 502B. In the ferrite core assembly 60, as depicted by FIG. 9, the first ferrite core 500A is arranged on the second ferrite core 500B according to the mounting direction 2 so that the first engagement face 502A faces the second engagement face 502B.

Unlike the preceding embodiments, in the fifth embodiment the first ferrite core 500A has a shape that is complementary to but different from the shape of the second ferrite core 500B. The exploded view of FIG. 10 illustrates both the first ferrite core 500A and the second ferrite core 500B. Thereafter, references is made to FIG. 9 and FIG. 10.

The ferrite core assembly 50 comprises two distinct channels 26, 28. Each channels 26, 28 has a rectangular cross-section in a plane parallel to the front face 12, i.e. in an (XY) plane. On the front face 12, respectively on the back face 14, each channel 26, 28 is at least partially chamfered inwardly towards the back face 14, respectively towards the front face 12. It allows preventing sharp edges that could scrape or damage the electrical terminal during their insertion in the ferrite core assembly. Each channels 26, 28 are respectively dimensioned for receiving an electrical terminal. In particular, the channels 26, 28 are configured to receive an electrical terminal of rectangular cross-section.

In the fifth embodiment, like in the fourth embodiment, the first engagement face 502A and the second engagement 502B face provide mutual abutment between the first ferrite core 500A and the second ferrite core 500B in both opposite directions along the transversal direction 3. One direction along the transversal direction 3 is indicated by the arrow labelled with the reference sign (3). The opposite direction along the transversal direction 3 is shown by the arrow labelled with the reference sign (−3). The directions (3) and (−3) along the transversal direction 3 are parallel but opposite to each other. The transversal direction 3 is respectively perpendicular to the extension direction 1 and the mounting direction 2. The transversal direction 3 is parallel to the X-axis of the Cartesian coordinate system shown in FIGS. 9 and 10.

The first ferrite core 500A is provided with two locking recesses 504A, 506A. In the example illustrated by FIGS. 9 and 10, the two locking recesses 504A, 506A have identical shape and dimension. Hence, the structural description thereafter of one of the locking recesses 504A, 506A applies to the other.

The locking recesses 504A, 506A are respectively deepened perpendicularly from the engagement face 502A (i.e. along the Y-axis) and extends longitudinally along the extension direction 1 (i.e. along the Z-axis). The locking recesses 504A, 506A have respectively a depth indicated by the reference sign 508A. For the first locking recess 504A, the depth 508A is defined along the Y-axis between the engagement face 502A and a bottom surface 510A of the first locking recess 504A. For the first locking recess 506A, the depth 508A is defined along the Y-axis between the engagement face 502A and a bottom surface 512A of the second locking recess 506A.

The first locking recess 504A comprises two opposite walls 514A, 516A. The two opposite walls 514A, 516A extend in respective planes parallel to the (YZ) plane. The first wall 514A is the wall closest to the lateral wall 22. The second wall 516A is positioned opposite to the first wall 514A. The two opposite walls 514, 516A are separated by a distance along the X-axis, which defines the width 518A of the first locking recess 504A.

The second locking recess 506A comprises two opposite walls 520A, 522A. The two opposite walls 520A, 522A extend in respective planes parallel to the (YZ) plane. The first wall 520A is the wall closest to the lateral wall 18. The second wall 522A is positioned opposite to the first wall 520A. The two opposite walls 520A, 522A are separated by a distance along the X-axis, which defines the width 518A of the second locking recess 506A. The first locking recess 504A and the second locking recess 506A have the same width.

The second ferrite core 500B is provided with two locking ridges 524B, 526B. In the example illustrated by FIGS. 9 and 10, the two locking ridges 524B, 526B have identical shape and dimension. Hence, the structural description thereafter of one of the locking ridges 524B, 526B applies to the other.

Each locking ridge 524B, 526B has a solid rectangular cross-section in a plane parallel to the front face 12. Each locking ridge 524B, 526B projects perpendicularly from the second engagement face 402B (i.e. along the Y-axis) and extends longitudinally along the extension direction 1 (i.e. along the X-axis), in particular from the front face 12 until the back face 14.

The first locking ridge 524B comprises two opposite walls 527B, 528B. The two opposite walls 527B, 528B extend in respective planes parallel to the (YZ) plane. The first wall 527B is the wall closest to the lateral wall 22. The second wall 528B is positioned opposite to the first wall 527B. The two opposite walls 527B, 528B are separated by a distance along the X-axis, which defines the width 530B of the first locking ridge 524B. The first locking ridge 524B comprises a top surface 532B. The top surface 532B connects the two opposite walls 527B, 528B. The top surface 532B extends in a (XZ) plane. The top surface 532B has a width corresponding to the width 530B. The first locking ridge 524B has a height 534B. The height 534B is defined along the Y-axis between the second engagement face 502B and the top surface 532B of the first locking ridge 524B.

The second locking ridge 526B comprises two opposite walls 536B, 538B. The two opposite walls 536B, 538B extend in respective planes parallel to the (YZ) plane. The first wall 536B is the wall closest to the lateral wall 18. The second wall 538B is positioned opposite to the first wall 536B. The two opposite walls 536B, 538B are separated by a distance along the X-axis, which defines the width 530B of the second locking ridge 526B. The first locking ridge 524B and the second locking ridge 526B have the same width 530B. The second locking ridge 526B comprises a top surface 540B. The top surface 540B connects the two opposite walls 536B, 538B. The top surface 540B extends in a (XZ) plane. The top surface 540B has a width corresponding to the width 530B. The second locking ridge 526B has a height 534B, like the height 534B of the first locking ridge 524B.

In the fifth embodiment, the rectangular channel 26 is defined between the first locking recess 504A of the first ferrite core 500A and the top surface 532B of the first locking ridge 524B of the second ferrite core 500B. More precisely, the rectangular channel 26 has a first surface defined by the top surface 532B of the first locking ridge 524B of the second ferrite core 500B, a second surface defined by the bottom surface 510A of the first locking recess 504A of the first ferrite core 500A, a third surface defined by the first wall 514A of the first locking recess 504A of the first ferrite core 500A and a fourth surface defined by second wall 516A of the first locking recess 504A of the first ferrite core 500A. The rectangular channel 28 is defined between the second locking recess 506A of the first ferrite core 500A and the top surface 540B of the second locking ridge 526B of the second ferrite core 500B. More precisely, the rectangular channel 28 has a first surface defined by the top surface 540B of the second locking ridge 526B of the second ferrite core 500B, a second surface defined by the bottom surface 512A of the second locking recess 506A of the first ferrite core 500A, a third surface defined by the first wall 520A of the second locking recess 506A of the first ferrite core 500A and a fourth surface defined by the second wall 522A of the second locking recess 506A of the first ferrite core 500A.

The respective depth 508A of the locking recesses 504A, 506A is greater than the respective height 543B of the locking ridge 524B, 526B. In particular, the difference between the respective depth 508A of the locking recesses 504A, 506A and the respective height 543B of the locking ridge 524B, 526B forms a gap allowing the insertion of an electrical terminal in the respective channels 26, 28.

In the fifth embodiment, the locking recesses 504A, 506A and the locking ridges 524B, 526B are arranged such that in the ferrite core assembly 50 as shown by FIG. 9, the first locking ridge 524B of the second ferrite core 500B is received in the first locking recess 504A of the first ferrite core 500A. The second locking ridge 526B of the second ferrite core 500B is received in the second locking recess 506A of the first ferrite core 500A. The width 518A of the locking recesses 504A, 506A may be slightly greater than the width 530B of the locking ridges 524B, 526B to allow the accommodation of the locking ridge 524B, 526B within the respective the locking recesses 504A, 506A.

Hence, in the fourth embodiment, the first locking ridge 524B of the second ferrite core 500B is partially received and interlocked in the first locking recess 504A of the first ferrite core 500A. A first form-fit connection is formed between the first locking recess 504A of the first ferrite core 500A and the first locking ridge 524B of the second ferrite core 500B. The second locking ridge 526B of the second ferrite core 500B is partially received and interlocked in the second locking recess 506A of the first ferrite core 500A. A second form-fit connection is formed between the second locking recess 506A of the first ferrite core 500A and the second locking ridge 526B of the second ferrite core 500B.

The wall 514A of the first locking recess 504A of the first ferrite core 500A abuts against the wall 516B of the first locking ridge 524B of the second ferrite core 500B along the direction (3) of the transversal direction 3.

The wall 516A of the first locking recess 504A of the first ferrite core 500A abuts against the wall 528B of the first locking ridge 524B of the second ferrite core 500B along the opposite direction (−3) of the transversal direction 3.

The wall 522A of the second locking recess 506A of the first ferrite core 500A abuts against the wall 538B of the second locking ridge 526B of the second ferrite core 500B along the direction (3) of the transversal direction 3.

The wall 520A of the second locking recess 506A of the first ferrite core 500A abuts against the wall 536B of the second locking ridge 526B of the second ferrite core 500B along the opposite direction (−3) of the transversal direction 3.

Consequently, in the fifth embodiment, the first engagement face 502A with its locking recesses 504A, 506A and the second engagement face 502B, with its locking ridges 524B, 526B provide mutual abutment between the first ferrite core 500A and the second ferrite core 500B in both opposite directions (3) and (−3) along the transversal direction 3.

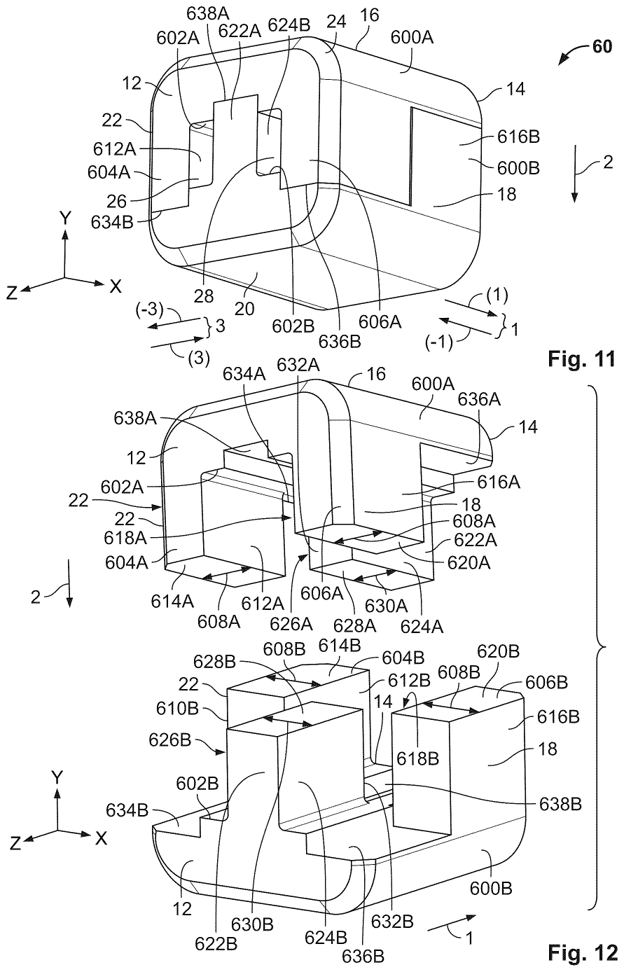

FIG. 11 shows a ferrite core assembly 60 according to a sixth embodiment.

Elements with the same reference numeral already described and illustrated in FIGS. 1 and 2 will not be described in detail again but reference is made to their description above.

According to the invention, the ferrite core assembly 60 comprises a first ferrite core 600A and a second ferrite core 600B. The first ferrite core 600A comprises a first engagement face 602A. The second ferrite core 600B comprises a second engagement face 602B. In the ferrite core assembly 60, the first ferrite core 600A is arranged on the second ferrite core 600B according to the mounting direction 2 so that the first engagement face 602A faces the second engagement face 602B.

In the sixth embodiment, like in the first, second, third and fourth embodiments, the first ferrite core 600A and the second ferrite core 600B have the same shape. The description of the one of the ferrite cores 600A, 600B thus equally applies to the other ferrite core 600A, 600B.

The first ferrite core 600A is provided with a first lateral locking ridge 604A and a second lateral locking ridge 606A. The first and second lateral locking ridges 604A, 606A respectively extends from the back face 14 and partially only towards the front face 12 along the extension direction 1 (i.e. the X-axis). The first lateral locking ridge 604A and the second lateral locking ridge 606A are both flush with the back face 14 and the lateral faces 18, 22 but not with the front face 12.

The second ferrite core 600B is provided with a first lateral locking ridge 604B and a second lateral locking ridge 606B. The first and second lateral locking ridges 604B, 606B respectively extends from the front face 12 and partially only towards the back face 14 along the extension direction 1 (i.e. the X-axis). The first lateral locking ridge 604B and the second lateral locking ridge 606B are both flush with the front face 12 and the lateral faces 18, 22 but not with the back face 14.

In the first ferrite core 600A, the first lateral locking ridge 604A comprises two lateral walls 610A, 612A. The external lateral wall 610A is flush with the lateral face 22. The internal lateral wall 612A is opposite to the external lateral wall 610A. The lateral walls 610A, 612A extend in a (YZ) plane. The first lateral locking ridge 604A is provided with a top surface 614A. The top surface 614A connects the two lateral walls 610A, 612A. The top surface 614A extends in a (XZ) plane. The top surface 614A has a width 608A. The width 608A is defined between the internal lateral wall 612A and the external lateral wall 610A along the X-axis. The same description applies to the second ferrite core 600B, with the above reference signs replaced by the Latin letter “B”.

In the first ferrite core 600A, the second lateral locking ridge 606A comprises two lateral walls 616A, 618A. The external lateral wall 616A is flush with the lateral face 18. The internal lateral wall 618A is opposite to the external lateral wall 616A. The lateral walls 616A, 618A extend in a (YZ) plane. The second lateral locking ridge 606A is provided with a top surface 620A. The top surface 620A connects the two lateral walls 616A, 618A. The top surface 620A extends in a (XZ) plane. The top surface 620A has the width 608A. In the example of FIGS. 11 and 12, the width 608A of the first lateral locking ridge 604A is the same than the width (608A) of the second lateral locking ridge 606A. The same description applies to the second ferrite core 600B, with the above reference signs replaced by the Latin letter “B”.

The respective width 608A of the lateral locking ridges 604A, 606A are the same than the respective widths 608B of the lateral locking ridges 604B, 606B.

The first ferrite core 600A further comprises a central locking ridge 622A. The central locking ridge 622A extends from the back face 14 and partially only towards the front face 12 along the extension direction 1 (i.e. the X-axis). The central locking ridge 622A extends along the extension direction 1 (i.e. the X-axis) towards the front face 12 until the two lateral locking ridges 604A, 606A begins. The central locking ridge 622A comprises two lateral walls 624A, 626A. The lateral walls 624A, 626A extend in a (YZ) plane. The central locking ridge 622A is provided with a top surface 628A. The top surface 628A connects the two lateral walls 624A, 626A. The top surface 628A extends in a (XZ) plane. The top surface 628A has a width 630A. In the example of FIGS. 11 and 12, the width 630A of the central locking ridge 622A is the same than the width 608A of the lateral locking ridges 604A, 606A. The front face of the central locking ridge 622A corresponds to the back face 14 of the ferrite core assembly 60. The back face 632A of the central locking ridge 622A is opposite to the back face 14. The back face 632A extends in a (XY) plane.

Similarly, the second ferrite core 600B comprises a central locking ridge 622B. The central locking ridge 622B extends from the front face 12 and partially only towards the back face 14 along the extension direction 1 (i.e. the X-axis). The central locking ridge 622B extends along the extension direction 1 (i.e. the X-axis) towards the back face 14 until the two lateral locking ridges 604B, 606B begins. The central locking ridge 622A comprises two lateral walls 624B, 626B. The lateral walls 624B, 626B extend in a (YZ) plane. The central locking ridge 622B is provided with a top surface 628B. The top surface 628B connects the two lateral walls 624B, 626B. The top surface 628B extends in a (XZ) plane. The top surface 628B has a width 630B. In the example of FIGS. 11 and 12, the width 630B of the central locking ridge 622B is the same than the width 608A of the lateral locking ridges 604B, 606B. The front face of the central locking ridge 622B corresponds to the front face 12 of the ferrite core assembly 60. The back face 632B of the central locking ridge 622B is opposite to the front face 12. The back face 632B extends in a (XY) plane.

The first ferrite core 600A is further provided with two lateral locking recesses 634A, 636A and one central locking recess 638A. The two lateral locking recesses 634A, 636A respectively extends along the extension direction 1 (i.e. X-axis) from the back face 14 and partially only towards the front face 12. The central locking recess 638A extends along the extension direction 1 (i.e. X-axis) from the front face 12 and partially only towards the back face 14. More specifically, the first lateral locking recess 634A extends along the extension direction 1 (i.e. X-axis) until the first lateral locking ridge 604A starts. The second lateral locking recess 636A extends along the extension direction 1 (i.e. X-axis) until the second lateral locking ridge 606A starts. The central lateral locking recess 638A extends along the extension direction 1 (i.e. X-axis) until the central locking ridge 622A starts. The central locking recess 638A is opened to the front face 12. The first lateral locking recess 634A is opened to the back face 14 and the lateral face 22. The second lateral locking recess 636A is opened to the back face 14 and the lateral face 18. The width (608A) of the first lateral locking recess 634A of the first ferrite core A corresponds to the width 608B of the first locking ridge 604B of the second ferrite core B. The width (608A) of the second lateral locking recess 636A of the first ferrite core A corresponds to the width 608B of the second locking ridge 606B of the second ferrite core B. The width (630A) of the central locking recess 638A of the first ferrite core A corresponds to the width 630B of the central locking ridge 622B of the second ferrite core B.

The first ferrite core 600B is similarly provided with two lateral locking recesses 634B, 636B and one central locking recess 638B. The two lateral locking recesses 634B, 636B respectively extends along the extension direction 1 (i.e. X-axis) from the front face 12 and partially only towards the back face 14. The central locking recess 638B extends along the extension direction 1 (i.e. X-axis) from the back face 14 and partially only towards the front face 12. More specifically, the first lateral locking recess 634B extends along the extension direction 1 (i.e. X-axis) until the first lateral locking ridge 604B starts. The second lateral locking recess 636B extends along the extension direction 1 (i.e. X-axis) until the second lateral locking ridge 604A starts. The central lateral locking recess 638B extends along the extension direction 1 (i.e. X-axis) until the central locking ridge 622B starts. The central locking recess 638B is opened to the back face 14. The first lateral locking recess 634B is opened to the front face 12 and the lateral face 22. The second lateral locking recess 636B is opened to the front face 12 and the lateral face 18. The width (608B) of the first lateral locking recess 634B of the first ferrite core 600B corresponds to the width 608A of the first locking ridge 604A of the first ferrite core 600A. The width (608B) of the second lateral locking recess 636B of the second ferrite core 600B corresponds to the width 608A of the second locking ridge 606B of the first ferrite core 600A. The width (630B) of the central locking recess 638B of the second ferrite core 600B corresponds to the width 630A of the central locking ridge 622A of the first ferrite core 600A.

The rectangular channel 26 is defined between the first engagement face 602A, the second engagement face 602B, the internal lateral wall 612A and the lateral wall 626B. The rectangular channel 28 is defined between the first engagement face 602A, the second engagement face 602B, the internal lateral wall 618A and the lateral wall 624B. The greatest dimension of the respective rectangular channel 26 extends along the mounting direction 2, i.e. like the extension direction of the locking ridges 604A, 606B, 622A, 604B, 606B, 622B.

In the sixth embodiment, the first engagement face 602A and the second engagement 602B thus face provide mutual abutment between the first ferrite core 600A and the second ferrite core 600B in both opposite directions along the transversal direction 3. One direction along the transversal direction 3 is indicated by the arrow labelled with the reference sign (3). The opposite direction along the transversal direction 3 is shown by the arrow labelled with the reference sign (−3). The directions (3) and (−3) along the transversal direction 3 are parallel but opposite to each other. The transversal direction 3 is respectively perpendicular to the extension direction 1 and the mounting direction 2. The transversal direction 3 is parallel to the X-axis of the Cartesian coordinate system shown in FIG. 11.

In the ferrite core assembly 60, the central locking ridge 622A is received and interlocked in the central locking recess 638B. This interlocked arrangement provide a form-fit connection between the first ferrite core 600A and the second ferrite core 600B. A displacement of the first ferrite core 600A with respect to the second ferrite core 600B is blocked in both opposite directions (3) and (−3) along the transversal direction 3.

Similarly, as visible in FIG. 11, the central locking ridge 622B is received and interlocked in the central locking recess 638A. This interlocked arrangement provide a form-fit connection between the first ferrite core 600A and the second ferrite core 600B. A displacement of the first ferrite core 600A with respect to the second ferrite core 600B is blocked in both opposite directions (3) and (−3) along the transversal direction 3.

The first lateral locking ridge 604A is received in the first lateral recess 634B. A displacement of the first ferrite core 600A with respect to the second ferrite core 600B is blocked in the direction (3) along the transversal direction 3, in particular by means of the abutment of the internal lateral wall 612A against the first lateral recess 634B. The second lateral locking ridge 606A is received in the second lateral recess 636B. A displacement of the first ferrite core 600A with respect to the second ferrite core 600B is blocked in the direction (−3) along the transversal direction 3, in particular by means of the abutment of the internal lateral wall 618A against the second lateral recess 636B.

Similarly, the first lateral locking ridge 604B is received in the first lateral recess 634A. A displacement of the first ferrite core 600A with respect to the second ferrite core 600B is blocked in the direction (3) along the transversal direction 3, in particular by means of the abutment of the internal lateral wall 612A against the first lateral recess 634A. The second lateral locking ridge 606B is received in the second lateral recess 636B. A displacement of the first ferrite core 600A with respect to the second ferrite core 600B is blocked in the direction (−3) along the transversal direction 3, in particular by means of the abutment of the internal lateral wall 618B against the second lateral recess 636B.

In the sixth embodiment, the first engagement face 602A and the second engagement 602B face thus further provide mutual abutment between the first ferrite core 600A and the second ferrite core 600B in both opposite directions along the extension direction 1. One direction along the transversal direction 1 is indicated by the arrow labelled with the reference sign (1). The opposite direction along the transversal direction 1 is shown by the arrow labelled with the reference sign (−1). The directions (1) and (−1) along the extension direction 1 are parallel but opposite to each other. The extension direction 1 is respectively perpendicular to the mounting direction 2 and the transversal direction 3. The extension direction 1 is parallel to the Z-axis of the Cartesian coordinate system shown in FIG. 11.

A displacement of the first ferrite core 600A with respect to the second ferrite core 600B is blocked in both directions (1) and (−1) along the extension direction 1 by the mutual abutment of the first locking ridge 604A and the first locking ridge 604B along the extension direction 1, the mutual abutment of the second locking ridge 606A and the second locking ridge 606B along the extension direction 1 and the mutual abutment of the central locking ridge 622A and the central locking ridge 622A along the extension direction 1.

Each the ferrite core assembly 10, 20, 30, 40, 50, 60 are adapted for an electrical connector, in particular for a pyrotechnic connector to be plugged in a mating connector of a safety restraint system.

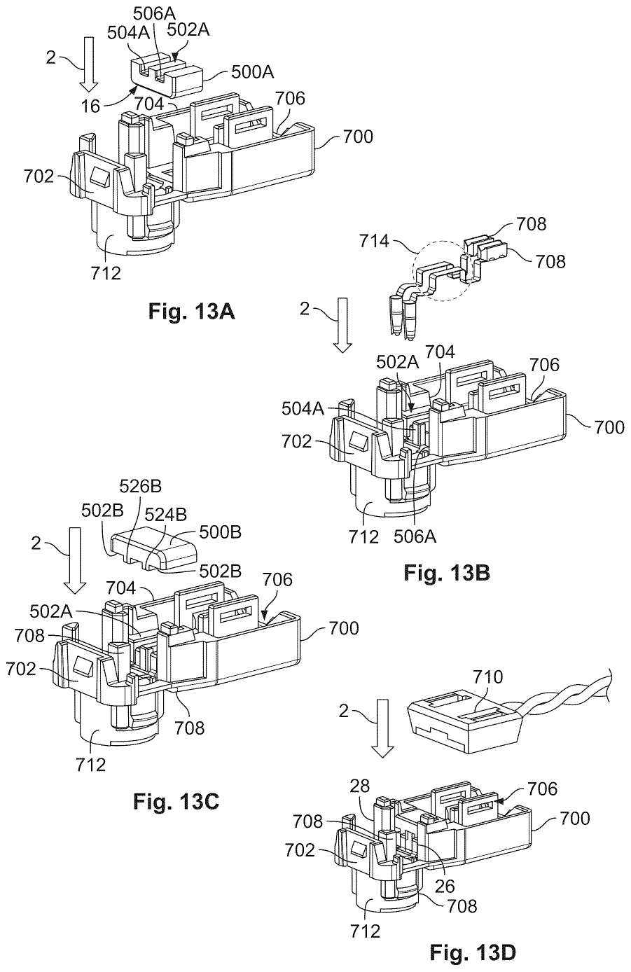

FIGS. 13A to 13D illustrates successive steps of an assembly method for assembling a ferrite core assembly, in particular a ferrite core assembly 50 according to the fifth embodiment, into an electrical connector 700. The assembly method depicted by FIGS. 13A-D is, however, applicable with a ferrite core assembly according to any of the above described embodiments.

The electrical connector 700, as shown in FIG. 13A, may be a pyrotechnic connector, also known as a squid connector. The electrical connector 700 is configured to be plugged along a mounting direction 2 into a mating connector (not represented), particularly a mating connector used in a safety restraint system.

The electrical connector 700 comprises a housing 702. The housing 702 comprises a first receptacle 704 for accommodating the ferrite core assembly 50. The housing 702 comprises a second receptacle 706 for receiving electrical terminals 708 and a wire fixture 710 and/or cables. The electrical connector 700 comprises a mating portion 712 configured to mate with a corresponding mating connector (not represented).

At a step (A) of the assembly method, shown in FIG. 13A, the first ferrite core 500A is assembled vertically to the electrical connector 700. More precisely, the first ferrite core 500A is inserted along the mounting direction 2 into the first receptacle 704.

As shown in step (B) of the assembly method, shown in FIG. 13B, the lateral face 16 of the first ferrite core 500A lies on a bottom surface of the receptacle 704. At the step (B) of the assembly method, two electrical terminal 708 are assembled vertically to the electrical connector 700. More precisely, a first electrical terminal 708 is inserted along the mounting direction 2 into the first locking recess 504A and a second electrical terminal 708 is inserted along the mounting direction 2 into the second locking recess 506A. The rectangular locking recesses 504A, 506B help guiding the alignment of the respective rectangular portions 714 of the electrical connectors 708 in the first ferrite core 500A.

During step (C) of the assembly method, shown in FIG. 13C, the second ferrite core 500B is inserted is assembled vertically to the electrical connector 700. More precisely, the second ferrite core 500B is inserted along the mounting direction 2 into the first receptacle 704 and the second ferrite core 500B is arranged on the first ferrite core 500A. The first ferrite core 500A is then assembled with the second ferrite core 500B to form a ferrite core assembly 50.

In the ferrite core assembly 50 shown in step (D) of the assembly method, shown in FIG. 13D, the first engagement face 502A is in surface contact with the second engagement face 502B. The electrical terminal 708 are received between respective channels 26, 28 formed between the locking recesses 504A, 506B of the first ferrite core 500A and the locking ridges 524B, 526B of the second ferrite core 500B.

A step (D) of the assembly method, the wire fixture 710 is assembled vertically to the electrical connector 700. More precisely, the wire fixture 710 is inserted along the mounting direction 2 into the second receptacle 706.

This assembly method allows assembling the different components along a single direction, namely the mounting direction 2, enabling a vertical assembly process. This approach ease the assembly process.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A ferrite core assembly for an electrical connector, in particular for a pyrotechnic connector to be plugged in a mating connector of a safety restraint system, the ferrite core assembly comprising:
a first ferrite core comprising a first engagement face, and
a second ferrite core comprising a second engagement face,
the first ferrite core is configured to be arranged on the second ferrite core according to a mounting direction so that the first engagement face is facing the second engagement face,
at least one channel for receiving a terminal or a wire along an extension direction is defined between the first engagement face and the second engagement face, the extension direction being perpendicular to the mounting direction, and
the first engagement face and the second engagement face provides an abutment of the first ferrite core against the second ferrite core along a transversal direction, wherein the transversal direction is respectively perpendicular to the mounting direction and the extension direction.

2. The ferrite core assembly according to claim 1, wherein the first engagement face and the second engagement face provide mutual abutment between the first ferrite core and the second ferrite core in both opposite directions along the transversal direction.

3. The ferrite core assembly according to claim 1, wherein the first ferrite core and the second ferrite core have the same shape.

4. The ferrite core assembly according to claim 1, wherein the first ferrite core has a shape that is complementary to and different from the shape of the second ferrite core.

5. The ferrite core assembly according to claim 1, wherein at least one of the first ferrite core and the second ferrite core is provided with at least one locking ridge projecting perpendicularly from its engagement face and extending longitudinally along the extension direction.

6. The ferrite core assembly according to claim 1, wherein at least one locking ridge of the first ferrite core abuts against at least one locking ridge of the second ferrite core along the transversal direction.

7. The ferrite core assembly according to claim 6, wherein the at least one locking ridge comprises a lateral wall parallel to a lateral face of the first ferrite core or the second ferrite core, the lateral face being defined in a plane formed by the extension direction and the mounting direction.

8. The ferrite core assembly according to claim 1, wherein at least one of the first ferrite core and the second ferrite core is provided with at least one locking recess deepening perpendicularly from the respective engagement face of the ferrite core and extending longitudinally along the extension direction.

9. The ferrite core assembly according to claim 8, wherein at least one locking ridge of the first ferrite core abuts against at least one locking ridge of the second ferrite core along the transversal direction, the at least one locking ridge of the first ferrite core, respectively of the second ferrite core, is at least partially received and interlocked in the at least one locking recess of the second ferrite core, respectively of the first ferrite core.

10. The ferrite core assembly according to claim 1, wherein the at least one channel has a rectangular cross-section in a plane formed by the mounting direction and the transversal direction.

11. The ferrite core assembly according to claim 1, wherein said ferrite core assembly comprises two distinct channels.

12. The ferrite core assembly according to claim 1, wherein at least one of the first ferrite core and the second ferrite core comprises a recess extending along the extension direction, and the at least one channel is partially formed by said recess.

13. The ferrite core assembly according to claim 1, wherein the at least one channel is formed between the at least one locking ridge of the first ferrite core, respectively of the second ferrite core, and the second engagement face of the second ferrite core, respectively of the first engagement face of the first ferrite core.

14. The ferrite core assembly according to claim 1, wherein the first engagement face and the second engagement face are further configured to provide an abutment of the first ferrite core against the second ferrite core along the extension direction.

15. An electrical connector, in particular for a pyrotechnic connector, to be plugged in a mating connector, in particular a mating connector of a safety restraint system, along a mounting direction, the electrical connector comprising:
a connector housing for housing an electrical terminal or a wire, and
a ferrite core assembly, the ferrite core assembly being accommodated in the connector housing, and
the ferrite core assembly comprises at least one channel for receiving the electrical terminal or wire along an extension direction, the extension direction being perpendicular to the mounting direction, and
the ferrite core assembly comprises a first ferrite core comprising a first engagement face and a second ferrite core comprising a second engagement face,
the first ferrite core is configured to be arranged on the second ferrite core according to the mounting direction so that the first engagement face is facing the second engagement face, and
the first engagement face and the second engagement face are configured to provide an abutment of the first ferrite core against the second ferrite core along a transversal direction, wherein the transversal direction is respectively perpendicular to the mounting direction and the extension direction.

16. The electrical connector according to claim 15, wherein the first engagement face and the second engagement face provide mutual abutment between the first ferrite core and the second ferrite core in both opposite directions along the transversal direction.

17. The electrical connector according to claim 15, wherein the first ferrite core and the second ferrite core have the same shape.

18. The electrical connector according to claim 15, wherein the first ferrite core has a shape that is complementary to and different from the shape of the second ferrite core.

19. The electrical connector according to claim 15, wherein at least one of the first ferrite core and the second ferrite core is provided with at least one locking ridge projecting perpendicularly from its engagement face and extending longitudinally along the extension direction.

20. The electrical connector according to claim 15, wherein at least one locking ridge of the first ferrite core abuts against at least one locking ridge of the second ferrite core along the transversal direction.
